(19) United States
(12) Patent Application Publication
(10) Pub. No.: US 2016/0114525 A1
(43) Pub. Date: Apr. 28, 2016

(54) METHOD OF MANUFACTURING ARTICLES HAVING INTERIOR PASSAGES

(71) Applicant: WGS Global Services, L.C., Flint, MI (US)

(72) Inventors: William J. Goetz, Flint, MI (US); Hilary J. Goetz, Grand Blanc, MI (US); Gary J. Holodnak, Cleveland, OH (US)

(21) Appl. No.: 14/920,067

(22) Filed: Oct. 22, 2015

Related U.S. Application Data
(60) Provisional application No. 62/067,190, filed on Oct. 22, 2014.

(51) Int. Cl. B29C 65/54; B32B 37/06; B32B 37/10

(52) U.S. Cl. CPC B29C 65/542; B32B 37/10; B32B 37/06; B32B 2305/72; B29L 2031/30

(57) ABSTRACT

A method of manufacturing an article having one or more interior passages. The method comprises constructing a plurality of individual segments of the article using a molding compound and aligning each of the plurality of individual segments with at least one other of the plurality of segments such that portions of one or more interior passages disposed in adjacent segments are aligned with each other. The method further comprises bonding each of the plurality of individual segments of the article to one or more adjacent segments to form an assembled article, and curing the assembled article by applying energy thereto to produce a completed article.

### CROSS REFERENCE TO RELATED APPLICATIONS

This application claims the benefit of U.S. Provisional Application No. 62/067,190 filed Oct. 22, 2014, the entire contents of which are hereby incorporated by reference.

### TECHNICAL FIELD

The present invention relates generally to the manufacture of articles formed of a molding compound and, more particularly, to the manufacture of an article formed of a molding compound and having one or more interior passages.

### BACKGROUND

Various types of articles having interior passages, for example, semi- or fully-encapsulated interior passages, are used in what may be considered high temperature environments. For example, in the automotive industry, articles such as engine blocks, cylinder heads, and other powertrain and driveline components of a vehicle (e.g., automobile) have interior passages and are located under the hood of the vehicle or at various other locations which may reach temperatures as high as about 140 to 170° C.

In view of the need to withstand such high temperatures, articles or components such as those identified above are typically formed of metal and manufactured as one-piece structures using, for example, casting, molding, and/or machining processes. Such manufacturing processes are not without their drawbacks or disadvantages, however.

For example, casting, molding, or machining an article having interior passages as a one-piece metallic structure often requires various secondary finishing and/or machining processes, and therefore, tooling corresponding thereto. Such secondary processes add both cost and complexity to the manufacturing process.

The inventors herein have recognized a need for a manufacturing process that will overcome one or more of the above-identified drawbacks or disadvantages.

### SUMMARY

According to one embodiment, there is provided a method of manufacturing an article having one or more interior passages. The method comprises constructing a plurality of individual segments of the article using a molding compound. The method further comprises aligning each of the plurality of individual segments with at least one other of the plurality of segments such that portions of one or more interior passages of the article disposed in adjacent segments are aligned with one another other, and then bonding each of the plurality of individual segments of the article to one or more adjacent segments to form an assembled article. The method still further comprises curing the assembled article by applying energy thereto to produce a completed article.

According to another embodiment, there is provided a method of manufacturing an article having one or more interior passages. The method comprises constructing a plurality of individual segments of the article using a molding compound comprising a phenol-based thermoset material. The method further comprises aligning each of the plurality of individual segments with at least one other of the plurality of segments such that portions of one or more interior passages disposed in adjacent segments are aligned with each other, and then bonding each of the plurality of individual segments of the article to one or more adjacent segments using an adhesive to form an assembled article. The method still further comprises curing the assembled article by applying energy thereto to produce a completed article.

According to yet another embodiment, there is provided an article of manufacture. The article comprises a body formed of a plurality of segments, wherein each segment is constructed of a molding compound and bonded to at least one other of the plurality of segments. The article includes one or more interior passages each extending at least partially through two or more adjacent segments of the plurality of segments.

### BRIEF DESCRIPTION OF THE DRAWINGS

One or more embodiments of the invention will hereinafter be described in conjunction with the appended drawings, wherein like designations denote like elements, and wherein:

FIG. 1 is a flow chart illustrating an embodiment of a method of manufacturing articles having interior passages;

FIGS. 2A and 2B are isometric views of an illustrative example of an article, namely, a cylinder head of a vehicle, which may be manufactured using the method illustrated in FIG. 1; and

FIGS. 3A and 3B are isometric views of another illustrative example of an article, namely, a cylinder head of a vehicle, which may be manufactured using the method illustrated in FIG. 1.

### DETAILED DESCRIPTION OF PREFERRED EMBODIMENTS

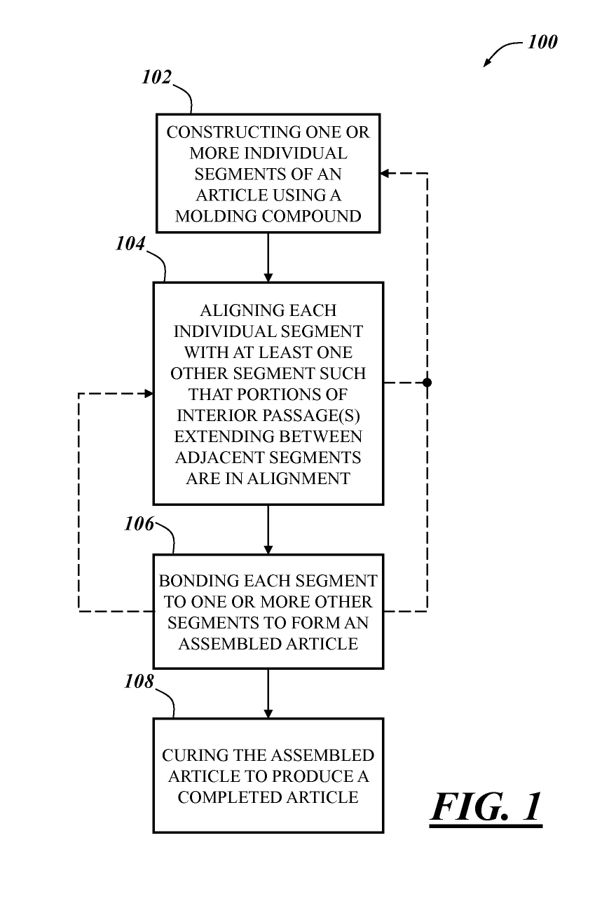

FIG. 1 depicts an illustrative embodiment of a method 100 of manufacturing articles having interior passages, for example and without limitation, encapsulated interior passages. In an embodiment, the method described herein may find application in the manufacture of articles or components intended for use in high temperature environments where the temperature may reach, for example 140 to 300° C. One example, though certainly not the only example, where method 100 may be particularly applicable is the manufacture of vehicle-related components, for example and without limitation, components intended for use under the hood of a vehicle where the temperature may reach upwards of 140 to 170° C. Non-limiting examples of components that may be manufactured using method 100 may include engine blocks, cylinder blocks, cylinder heads, transmission valve bodies, differential carriers and covers therefor, rear axle hubs, transfer cases, and/or other powertrain and/or driveline components for or of gas and diesel engines, as well as hybrid, electric, CNG, and/or hydrogen-based vehicles, etc. that may typically be formed as one-piece structures made of metal.

While the description below will be primarily with respect to the use of method 100 to manufacture vehicle-related articles, and components of a vehicle engine, in particular (e.g., a cylinder head), it will be appreciated that the present method may also find application in the manufacture of other articles or components both vehicle-related (e.g., automotive/automobile vehicles, marine vehicles, aerospace/aviation vehicles, etc.) and otherwise. For example, in at least some embodiments, method 100 may be used to manufacture various articles used in the aviation/aerospace industry, vehicle and non-vehicle (e.g., automotive and non-automotive) heating and cooling components (e.g., radiators), and/or firewalls, to cite a few possibilities. Accordingly, it will be understood that method 100 is not limited to the manufacture of any particular article(s).

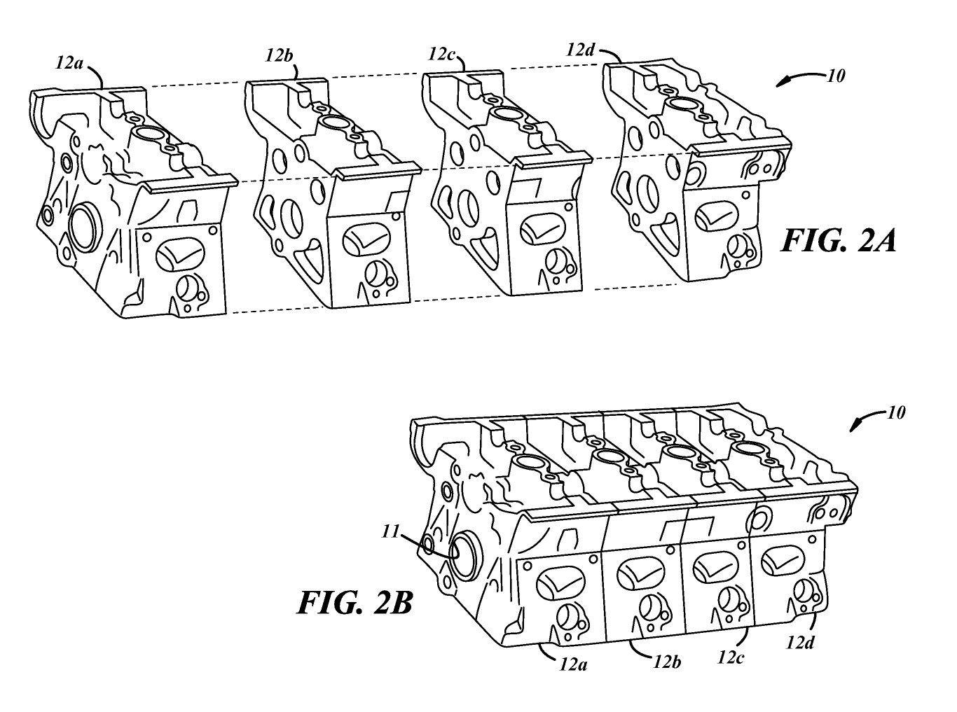

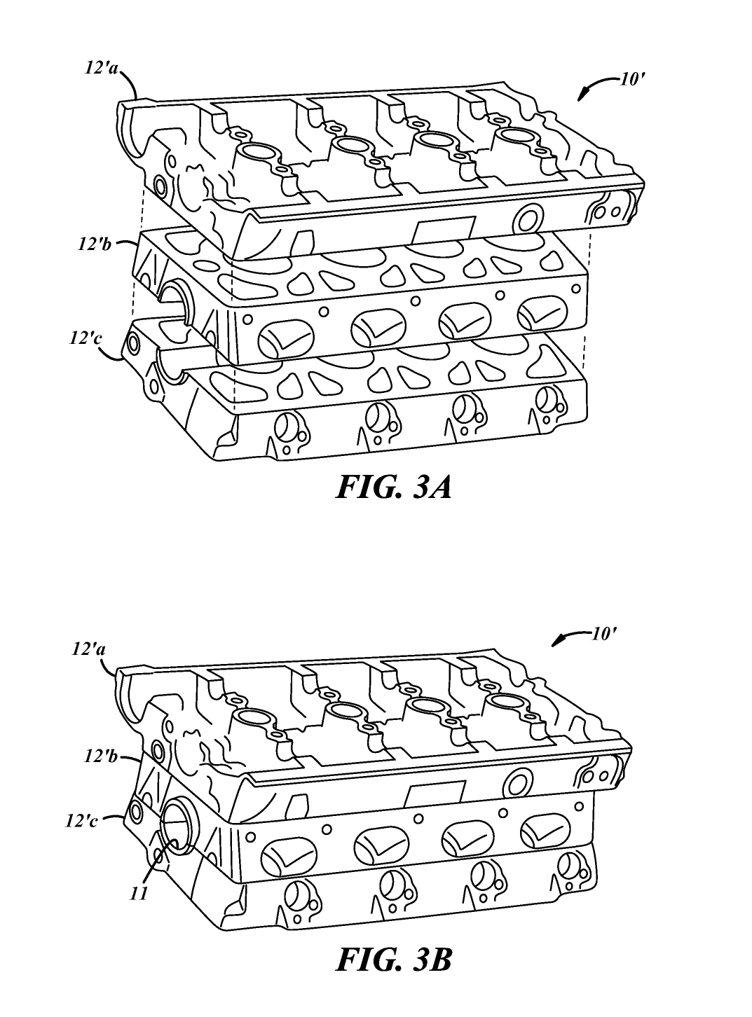

As illustrated in FIG. 1, method 100 includes a step 102 comprising constructing a plurality of individual segments of an article of interest using a molding compound. Depending on the particular application, the article may be segmented in a number of ways and into a number of segments. For example, in certain instances the article may divided into a number of equally sized segments, while in other instances the article may be divided into a number of segments that are not all equally sized. In certain instances the article may be segmented horizontally (see FIG. 2A), vertically (see FIG. 3A), or at one or more angles, while in other instances, the article may be segmented using a combination of vertical, horizontal, and/or angled segments. Further, how an article may be segmented (e.g., the number of segments and/or orientation of the segments (e.g., vertical, horizontal, etc.) may take into account various article-specific considerations or factors. For example, known stress points of the article, which may be determined empirically, are used to determine where and/or where not to segment the article (e.g., in at least certain instances it may not be desirable to segment the article along a stress point). Other considerations/factors may additionally or alternatively include ease of manufacture, article tolerances, specific arrangements or orientations of the interior passage(s), draw or draft angles required to extract a segment from the mold, and/or any number of other considerations.

In any event, step 102 may be performed in a number of ways. In at least some implementations, step 102 comprises constructing one or more of the plurality of segments using a molding process, for example and without limitation, an injection molding process or a compression molding process. In other implementations, step 102 comprises constructing one or more of the plurality of segments using a casting process. Various molding and casting processes are well known in the art, and therefore, a detailed description of such processes will not be provided. To summarize, however, an appropriate amount of the molding compound material is introduced (e.g., injected) into a suitable mold and held therein for a predetermined period of time. The material/molding compound is then cooled and the resulting segment is removed from the mold. It will be appreciated that particular details of the molding process will be dependent upon the particular article involved and molding material being used. In one non-limiting example, however, the temperature of the material being introduced into the mold may be about 80-190° C., the mold temperature may be about 160-190° C., and the curing time may be about 10-40 seconds per millimeter of wall thickness.

The molding compound used in step 102 may take a number of forms. In at least some implementations, the molding compound comprises a high performance thermoset material that can be easily injected or introduced into molds without defects or porosity, or at least without a predetermined amount of defects or porosity deemed to be unacceptable. In an embodiment, the molding compound comprises a phenol-based thermoset material (resin) that when cast or molded as described herein remains stable (e.g., the material does not plasticize or become partially fluid) and fire resistant at relatively high temperatures, for example, up to about 200 to 300° C., and in at least one embodiment, up to about 250° C. The molding compound may have one or more of the following characteristics rendering the material particularly suitable for use in a high temperature environment (e.g., 140 to 300° C., and in at least one embodiment, 200 to 300° C.): a density of 1.50 to 2.50 g/cm³, and in at least one embodiment, 1.70 to 2.06 g/cm³; a tensile modulus of 16,000 to 30,000 MPa, and in at least one embodiment, 16,500 to 29,500 MPa; a tensile strength of 75 to 175 MPa, and in at least one embodiment, 100 to 150 MPa; and a flexural strength of 150 to 300 MPa, and in at least one embodiment, 200 to 260 MPa. Examples of molding compounds that may be suitable for use include, but are certainly not limited to, Bakelite® PF 1110 and PF 6510, both of which are commercially available from Hexion Inc.

While particular values or ranges of values for various characteristics of the molding compound (e.g., temperature, density, tensile modulus and strength, and flexural strength) have been provided and specific examples of molding compounds deemed suitable have been identified, it will be appreciated that these values, ranges, and examples have been provided for illustrative purposes only, and that one or more other suitable values, ranges, and/or particular molding compounds may certainly be used instead. Accordingly, the present disclosure is not intended to be limited to any particular suitable value(s) or range(s) for the characteristics described above, or particular examples of suitable molding compounds.

Following the construction of some or all of the plurality of segments in step 102, method 100 may proceed to a step 104 of aligning two or more of the constructed segments with each other. In an embodiment, this may comprise aligning two or more of the segments such that portions of one or more interior passages of the article disposed in the segments being aligned are in alignment with each other such that a continuous passage extending at least partially through each of the aligned (two or more) segments is formed. In an embodiment, this step may be automated such that an appropriately configured machine or tool is configured to align the relevant segments, while in other embodiments this may be performed manually by a user. In at least some implementations, once two or more, but less than all, of the segments of the article are constructed in step 102 and aligned in step 104, method 100 may move to step 106 of bonding some or all of those particular segments together. Steps 102, 104, and/or 106 may then be repeated to construct, align, and/or bond additional segment(s). Alternatively, method 100 may not proceed to step 106 until all, or at least a certain number, of the required segments of the article are constructed in step 102 and aligned with one or more other segments in step 104.

Step 106 comprises bonding two or more of the plurality of segments constructed in step 102 and aligned in step 104 to one another, and when each required segment has been bonded to one or more other segments, an assembled article is formed. In an embodiment, step 106 comprises bonding adjacent segments together using a bonding material or agent, for example, an adhesive. As with the molding compound described above, the bonding agent or adhesive should be suitable for use in high temperature environments, for example, environments that may reach temperatures of about 140 to 170° C. or higher, and remain stable and fire resistant at temperatures of up to about 200 to 300° C., and in at least one embodiment, up to about 250° C. The adhesive must also be anti-corrosive so as to not comprise the integrity of the segments bonded together by the adhesive. One example of a suitable adhesive is a phenolic adhesive, for example, Arofene phenolic adhesive commercially available from Ashland, Inc. While particular values or ranges of values for a temperature characteristic of the adhesive or bonding agent has been provided, and one specific example of an adhesive has been identified, it will be appreciated that the temperature value/range and the example of a particular adhesive have been provided for illustrative purposes only, and that other suitable values, ranges, and/or particular adhesives may certainly be used instead. Accordingly, the present disclosure is not intended to be limited to any particular temperature value(s) or range(s), or particular examples of adhesives/bonding agents.

In any event, step 106 comprises applying the bonding agent being used to at least a portion of one or more of the segments being bonded together. This may comprise, for example, applying the bonding agent to the entirety of a portion of one or more of the segments being bonded together. For example, in an instance wherein two segments are being bonded together, bonding agent may be applied to the entirety of a portion of the first segment that contacts a portion of the second segment, the entirety of a portion of the second segment that contacts a portion of the first segment, or both. Alternatively, step 106 may comprise applying the bonding agent to less than the entirety of a portion of one or more of the segments being bonded together (e.g., completely or partially along the outer periphery, in the center, etc.). For example, in an instance wherein two segments are being bonded together, bonding agent may be applied to less than the entirety of a portion of the first segment that contacts a portion of the second segment, less than the entirety of a portion of the second segment that contacts a portion of the first segment, or both. In an embodiment, the application of the bonding agent may be an automated process performed by an appropriately configured machine or tool, while in other embodiments this may be performed manually by a user. In either instance, the bonding agent may be applied by brush rolling, spraying, and/or applying the bonding agent using preformed gaskets. Additionally, in at least some implementations, the bonding agent may be applied prior to the alignment of segments being bonded together in step 104, while in other implementations the agent may be applied after the segments are aligned in step 104. Following the application of the bonding agent, step 106 may comprise bringing the segments to be bonded together into engagement with each other, and then clamping them together using mechanical fasteners or other temporary retention techniques. Method 100 may then move to step 108 described below.

In another embodiment, rather than applying the adhesive to the segments prior to clamping the segments together as described above, step 106 may comprise clamping together the segments to be bonded to each other and then injecting the adhesive or bonding agent into predefined ports in one or more of the segments that will direct the adhesive to appropriate locations at which the segments being bonded together interface and/or contact each other.

Accordingly, it will be appreciated in view of the foregoing that step 106 may be performed in any number of ways, and therefore, the present disclosure is not intended to be limited to any particular way(s) of doing so.

In certain implementations, step 106 may be performed when two segments constructed in step 102 have been aligned in step 104 and regardless of whether all of the plurality of segments required to form the article have been constructed in step 102 or aligned with one or more other segments in step 104. In an embodiment wherein the article includes more than two segments, method 100 may comprise repeatedly performing steps 102, 104, and/or 106 until all of the segments have been constructed, aligned with, and bonded to at least one other segment. For example, assume for purposes of illustration only that the article comprises three segments. In at least some implementations, a first and a second segment may be constructed in step 102, aligned with each other in step 104, and bonded together in step 106. Following the bonding of the first and second segments in step 106, a third segment may then be constructed and/or aligned with and bonded to one of the first or second segments to form an assembled article.

In certain other implementations, however, step 106 may be performed only once all of the plurality of segments have been constructed in step 102 and/or aligned in step 104. For example, assume for purposes of illustration only that the article comprises three segments. In at least some implementations, the first, second and third segments are constructed in step 102, each segment is then aligned with at least one other of the segments in step 104, and then the segments may be bonded together in step 106 to form an assembled article.

In view of the foregoing, it will be appreciated that unless otherwise provided or required, the performance of the steps of method 100 described above are not necessarily limited to any particular order, and that the performance of steps 102, 104, and/or 106 may be implemented in any number of ways (e.g., sequentially, iteratively, etc.).

Once an assembled article has been formed in step 106, method 100 may move to step 108 of curing the assembled article to produce a completed article. Step 108 may be performed using any number of techniques known in the art, and therefore, a detailed description of techniques for curing the assembled article will not be provided. To summarize, however, step 108 may comprise applying energy (e.g., heat) to the assembled article to cause the assembled article to harden by, for example, the cross-linking of polymer chains of the segments and/or adhesive. In at least some implementations, step 108 comprises placing the assembled article in an appropriately configured oven and applying a predetermined amount of heat to the assembled article for a predetermined period of time. It will be appreciated that particular details of the curing process will be dependent upon the particular article involved and molding compound and bonding agent being used, and may be determined through empirical testing. The article having one or more interior passages (e.g., one or more semi-encapsulated passages (i.e., accessible from outside the article) and/or one or more fully-encapsulated passages (i.e., not accessible from outside the article)) may then cool and the article in a completed form may be removed from the oven. In at least some embodiments, no further processing (e.g., machining, finishing, etc.) is required to be performed on the completed article following step 108. Instead, the article may be inspected and then shipped, stored, or used.

As a result of the process or methodology described above, a completed article is produced that is comprised of a plurality of individually formed or constructed segments that are bonded together to form the article. Additionally, the interior passages of the article have tight or close tolerances, which, in an embodiment, may be about +/−0 to 0.1 mm, and in at least one implementation may be about +/−0.04 mm, and because both the material and adhesive used to produce the article are able to withstand high temperatures (e.g., about 250° C.), the article is suitable for use in any number of high temperature environments, for example, automotive applications where the temperature under the hood of a vehicle may reach upwards of, for example, about 140 to 170° C. or higher. Illustrative, non-limiting examples of one such article, namely, a cylinder head for a vehicle, are illustrated in FIGS. 2A-3B.

In the example shown in FIG. 2A, a cylinder head 10 having a plurality of interior passages (e.g., passage 11) is segmented horizontally and four individual segments 12 (12a-12d) of the cylinder head 10 are constructed in step 102 to have predetermined sizes and shapes. Those four segments 12a-12d are then sequentially, simultaneously, or both sequentially and simultaneously aligned with one another in step 104 (e.g., portions of interior passage(s) disposed in adjacent segments are aligned with one another), bonded together in step 106, and then cured in step 108 to produce the completed cylinder head 10 illustrated in FIG. 2B.

Similarly, in the example shown in FIG. 3A, a cylinder head 10′ having a plurality of interior passages (e.g., passage 11) is segmented vertically and three individual segments 12′ (12′ a-12′ c) of the cylinder head 10′ are constructed in step 102 to have predetermined sizes and shapes. Those three segments 12′ a-12′ c are then sequentially, simultaneously, or both sequentially and simultaneously aligned with one another in step 104, bonded together in step 106, and then cured in step 108 to produce the completed cylinder head 10′ illustrated in FIG. 3B.

While a cylinder head has been provided as one example of an article that may be formed using the methodology described herein, it will be appreciated that the present disclosure is not intended to be limited solely to the construction, formation, or manufacture of cylinder heads using the methodology described herein. Other examples of articles that may be formed using the methodology of the present disclosure include, for example and without limitation, engine blocks and other vehicle-related components or articles (e.g., vehicle engine components), as well as the articles, vehicle- or automobile-related and otherwise, identified elsewhere above.

It will be further appreciated in view of the foregoing that in at least certain implementations or embodiments, an advantage of the methodology described above is that secondary or post-production machining or finishing is either not required or is at least substantially reduced as compared to conventional manufacturing processes (e.g., those in which an article having one or more interior passages is manufactured as a one-piece metallic structure). As such, the need for various secondary tooling and/or other hardware typically required may be eliminated or reduced. Other advantages of at least certain implementations may include one or more of: reduced process steps, complexity, energy, and/or costs as compared to conventional processes; reduced weight (e.g., on the order of 20-25%, in certain instances) of the manufactured article as compared to (metal) articles manufactured using conventional processes; articles may be manufactured with closer or tighter tolerances as compared to conventional processes; and the method described herein allows for modular assembly of articles.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of manufacturing an article having one or more interior passages, the method comprising:
constructing a plurality of individual segments of the article using a molding compound;
aligning each of the plurality of individual segments with at least one other of the plurality of segments such that portions of one or more interior passages disposed in adjacent segments are aligned with each other;
bonding each of the plurality of individual segments of the article to one or more adjacent segments to form an assembled article; and
curing the assembled article by applying energy thereto to produce a completed article.

2. The method of claim 1, wherein the molding compound is such that the article is able to withstand temperatures of 200-300° C.

3. The method of claim 1, wherein the constructing step comprises one of injection molding or compression molding the plurality of individual segments.

4. The method of claim 1, wherein the bonding step comprises bonding each of the plurality of individual segments to one or more adjacent segments using an adhesive.

5. The method of claim 1, wherein the molding compound has a density of 1.50 to 2.50 g/cm³.

6. The method of claim 1, wherein the molding compound has a tensile modulus of 16,000 to 30,000 MPa.

7. The method of claim 1, wherein the molding compound has a tensile strength of 75 to 175 MPa.

8. The method of claim 1, wherein the molding compound has a flexural strength of 150 to 300 MPa.

9. The method of claim 1, wherein the article comprises a component of an engine of a vehicle.

10. An article manufactured using the method of claim 1.

11. An article comprising a component of a vehicle manufactured using the method of claim 1.

12. An article comprising a component of a vehicle engine manufactured using the method of claim 1.

13. An article of manufacture, comprising a body formed of a plurality of segments, wherein each segment is constructed of a molding compound and bonded to at least one other of the plurality of segments to form the article, wherein the article includes one or more interior passages extending at least partially through two or more of the plurality of segments.

14. The article of manufacture of claim 13, wherein the molding compound comprises a phenol-based thermoset material.

15. The article of manufacture of claim 13, wherein the molding compound is such that the article is able to withstand temperatures of 200-300° C.

16. The article of manufacture of 13, wherein the molding compound has a density of about 1.50 to 2.50 g/cm³.

17. The article of manufacture of claim 13, wherein the molding compound has a tensile modulus of 16,000 to 30,000 MPa.

18. The article of manufacture of claim 13, wherein the molding compound has a tensile strength of 75 to 175 MPa.

19. The article of manufacture of claim 13, wherein the molding compound has a flexural strength of 150 to 300 MPa.

20. The article of manufacture claim 13, wherein the article of manufacture comprises a component of a vehicle.

21. The article of manufacture of claim 20, wherein the component of the vehicle comprises a component of an engine of the vehicle.

22. A vehicle comprising the article of manufacture of claim 13.

23. A method of manufacturing an article having one or more interior passages, the method comprising:
constructing a plurality of individual segments of the article using a molding compound comprising a phenol-based thermoset material;
aligning each of the plurality of individual segments with at least one other of the plurality of segments such that portions of one or more interior passages disposed in adjacent segments are aligned with each other;
bonding each of the plurality of individual segments of the article to one or more adjacent segments using an adhesive to form an assembled article; and
curing the assembled article by applying energy thereto to produce a completed article.

24. The method of claim 23, wherein the molding compound is such that the article is able to withstand temperatures of 200-300° C.

25. The method of claim 23, wherein the article comprises a component of an engine of a vehicle.

26. An article manufactured using the method of claim 23.
